(19) United States
(12) Patent Application Publication
(10) Pub. No.: US 2010/0039906 A1
(43) Pub. Date: Feb. 18, 2010

(54) SYSTEM AND METHOD FOR CONVERTING A CD COLLECTION TO A DIFFERENT MEDIA OR FORMAT

(76) Inventor: Doug Strachota, Indianapolis, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/192,687

(22) Filed: Aug. 15, 2008

(51) Int. Cl. G11B 7/085

(52) U.S. Cl. 369/30.27; G9B/7.042

(57) ABSTRACT

A computer system and method is disclosed that transfer collections of CD's and/or DVD's containing audio and/or video to a digital format in an automated fashion. A computer system and method is disclosed that includes a computer, computer accessible media changer, and one or more CD/DVD information databases. Media changer can be an optical media changer, or a robotic device that loads CD's/DVD's from a stack into one or multiple optical media readers. As one example, the system and method can be used to transfer multiple music CD's to another computer-accessible media.

### CROSS-REFERENCE TO RELATED APPLICATIONS

This application claims the benefit of U.S. Provisional Application No. 60/526,230, filed Dec. 2, 2003. The application is incorporated herein in its entirety.

### BACKGROUND OF THE INVENTION

The present invention relates to computer systems, and more particularly, but not exclusively, relates to converting multiple optical media, such as compact discs, to a different media or format.

Most people own dozens of music CD's that they have collected over a period of time. To take advantage of their CD collection, people often transport the CD's physically for playing in a CD player. This becomes a hassle when having to transport multiple CD's around to the various locations where you may want to listen to the music. Some people solve the problem of physically carrying around their CD's by using a computer to convert one or more CD's in their collection into a format that they can play on a portable MP3 or other music player, such as the APPLE iPod device. The conversion process works by loading the music CD into a computer CD drive, using ripping software to copy the songs to the computer's hard drive, and then using the same or separate software to encode the songs into a format such as MP3 or WAV that can be loaded onto a portable player. After loading a portable music player's memory with a compressed version of songs from the original CD's, there is no need to carry around the original CD's. This manual process works fine as long as the number of CD's that need converted is very small. If someone has dozens of CD's that they would like to load onto a portable music player or other device, they have to manually load and repeat this process for each CD one by one. This can require dozens of hours of attention by the user to keep loading and attending to the CD's being converted.

Some people use an audio CD changer, such as the SONY Mega 300 CD Changer, to store and manage playback of their CD's through a home sound system. Many digital jukebox devices, such as the ESCIENT Fireball product, can control such audio CD changers and some can even copy one or more CD's in the CD changer to the jukebox hard drive or onto a CD-R/RW in an encoded format such as MP3. Once the songs on the CD's have been encoded, they can be used for playback on the jukebox device itself or from any CD playback device that supports the encoded format. For example, some digital jukebox devices have a port allowing for direct transfer of the compressed CD's onto a portable music device. Other jukeboxes provide the ability to play the song through the house sound system using the compressed format instead of taking the time to send the command to the CD changer to change to that physical CD. The problem with the audio CD changer conversion approach is that in order for the CD songs to be copied, they must actually be played through the audio port at regular speed (1×). By requiring playback through the audio port for the data to be accessible for copying means that it could take dozens or hundreds of hours for a large CD collection to be converted to a compressed format. This is not practical in such situations.

There is therefore a need for a faster and easier system and method for converting multiple CD's into a different media or format. The present invention is directed to meeting this and other needs.

### SUMMARY OF THE INVENTION

One form of the present invention is a system for transferring the data on a set of CD's and/or DVD's to a different format and/or media. Other forms include unique systems and methods to improve the transfer of audio and/or video data stored on a set of optical media to a compressed media. Another form includes operating a computer system that has a computer, CD/DVD changer, local CD/DVD information database, and an external CD/DVD information database. Another form includes operating a computer system that has a CD/DVD processing computer coupled to a CD/DVD Changer, the CD/DVD processing computer operative to transfer data from a set of CD's/DVD's in the CD/DVD changer to collection stored on a storage medium. Yet another form includes a system and method for converting multiple CD's/DVD's into a different format and loading the collection to a storage medium.

Further forms, embodiments, objects, advantages, benefits, features, and aspects of the present invention will become apparent from the detailed description and drawings contained herein.

### BRIEF DESCRIPTION OF THE DRAWINGS

FIG. 1 is a diagrammatic view of a computer system of one embodiment of the present invention.

FIG. 2a is the first portion of a process flow diagram for the system of FIG. 1 demonstrating the high level stages involved in transferring data on a CD/DVD collection to a different media.

FIG. 2b is the second portion of a process flow diagram for the system of FIG. 1 demonstrating the high level stages involved in transferring data on a CD/DVD collection to a different media.

FIG. 3 is a process flow diagram for the system of FIG. 1 demonstrating the stages involved in processing a CD/DVD collection and transferring the contents to a different media or format.

FIG. 4 is a process flow diagram for the system of FIG. 1 demonstrating the stages involved in identifying a CD/DVD using a database matching process.

FIG. 5 is a sample index generated by the system of FIG. 1 and stored on the compressed media.

### DETAILED DESCRIPTION OF SELECTED EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

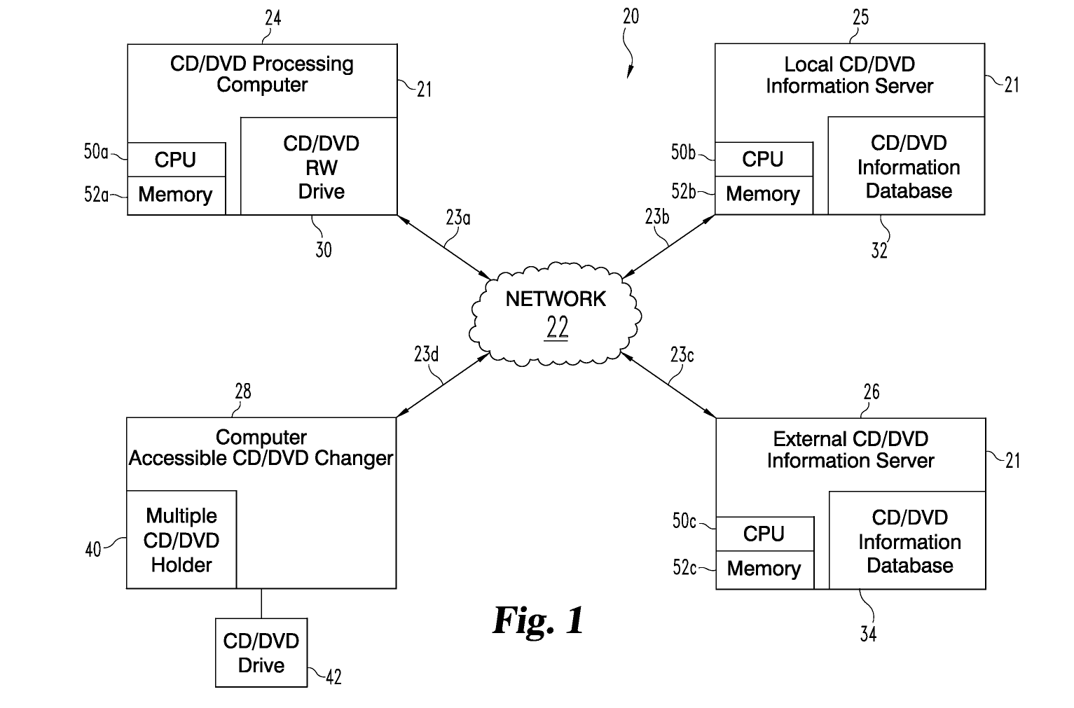

One embodiment of the present invention includes a system for converting a CD/DVD collection to a different format and/or a different media. FIG. 1 is a diagrammatic view of computer system 20 of one embodiment of the present invention. Computer system 20 includes computer network 22. Computer network 22 couples together a number of computers 21 over network pathways 23. More specifically, system 20 includes CD/DVD Processing Computer 24, Local CD/DVD Information Server 25, External CD/DVD Information Server 26, computer-accessible CD/DVD Changer 28, and CD/DVD Drive 42. While Computer-Accessible CD/DVD Changer 28 is shown accessible to CD/DVD Processing Computer 24 and other computers over network 22, CD/DVD Changer 28 can alternatively or additionally be connected directly to CD/DVD Processing Computer 24 via a direct connection such as Firewire or USB, or integrated as part of CD/DVD Processing Computer 24, to name a few non-limiting examples. CD/DVD Drive 42 is shown coupled to CD/DVD Changer 28. CD/DVD Drive 42 can be coupled to CD/DVD Changer 28 via a direct connection such as Firewire or USB, or integrated as part of CD/DVD Changer 28 and/or CD/DVD Processing Computer 24, to name a few non-limiting examples. Alternatively or additionally, CD/DVD Drive 42 can be coupled to CD/DVD Changer 28, CD/DVD Processing Computer 24, and/or other computers over network 22. CD/DVD Processing Computer 24 communicates with Multiple CD/DVD Holder 40 and CD/DVD Drive 42 to place a CD located in Multiple CD/DVD holder 40 into CD/DVD Drive 42. While computers 21 are illustrated as being a client or a server, it should be understood that any of computers 21 may be arranged to include both a client and server, just a client, or just a server. Furthermore, it should be understood that while three computers 21 are illustrated, more or fewer may be utilized in alternative embodiments.

Computers 21 include one or more processors or CPUs (50a, 50b, 50c, 50d, 50e, 50f, 50g, 50h, and 50i, respectively) and one or more types of memory (52a, 52b, 52c, 52d, 52e, 52f, 52g, 52h and 52i, respectively). Each memory 52a, 52b, 52c, 52d, 52e, 52f, 52g, 52h and 52i includes a removable memory device, which is not shown to preserve clarity. Each processor may be comprised of one or more components configured as a single unit. Alternatively, when of a multi-component form, a processor may have one or more components located remotely relative to the others. One or more components of each processor may be of the electronic variety defining digital circuitry, analog circuitry, or both. In one embodiment, each processor is of a conventional, integrated circuit microprocessor arrangement, such as one or more PENTIUM III or PENTIUM 4 processors supplied by INTEL Corporation of 2200 Mission College Boulevard, Santa Clara, Calif. 95052, USA.

Each memory (removable or otherwise) is one form of computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD); a magnetically encoded hard disc, floppy disc, tape, or cartridge media; or a combination of any of these memory types. Also, each memory may be volatile, nonvolatile, or a hybrid combination of volatile and nonvolatile varieties.

In one embodiment, CD/DVD Processing Computer 24 has one or more CD/DVD drives 30 and CD/DVD Chanter 28 has one or more integrated CD/DVD Drives 42. In other embodiments, CD/DVD Processing Computer 24 and/or CD/DVD Changer 28 do not have one or more integrated CD/DVD drives, but are operable to communicate with one or more external CD/DVD drives. The CD/DVD drives can be one of various possible types, such as CD-R, CD-RW, CD/DVD-R, or CD/DVD-RW, to name a few non-limiting examples. Alternatively or additionally, CD/DVD Information Servers 25 and 26 can also have one or more CD/DVD drives. The term CD, DVD, and/or CD/DVD as used herein is meant generically and can include a CD, DVD, both, either, or other optical or other media variations as would occur to a person of skill in the art. In addition, the term CD/DVD drive as used herein is meant generically and can include a CD drive, DVD drive, both, either, or other optical or other media readers as would occur to a person of skill in the art.

Optical media changer 28 is capable of holding multiple CD's/DVD's at one time in Multiple CD/DVD Holder 40 and then loading a selected CD/DVD into an internal or external CD/DVD Drive 42 as desired. CD/DVD Changer 28 can be any type of device that can hold multiple CD's and/or DVD's, automatically load a selected CD/DVD into a CD/DVD drive, and allow a computer to access the contents of the data on the CD/DVD in the drive. There can be one or multiple CD/DVD drives in the CD/DVD Changer. Multiple CD/DVD drives can be used for simultaneously processing multiple CD's/DVD's. CD/DVD Changer 28 can be an optical media changer or an optical storage mechanism such as the POWERFILE C200 device, which can hold dozens or hundreds of CD's/DVD's in various slots (Multiple CD/DVD Holder 40) and can load a specified CD/DVD as desired into a CD/DVD drive (CD/DVD Drive 42). CD/DVD Changer 28 can be a device that includes a robotic mechanism that is capable of placing CD's/DVD's from a CD/DVD stack (Multiple CD/DVD Holder 40) and loading them into a CD/DVD drive (CD/DVD Drive 42). Some non-limiting examples of a robotic mechanism include a robotic arm, gravity feed, or a carriage that moves. An example of such a robotic CD/DVD loading device is ComposerMAX Optical Disc Duplicator by PRIMERA TECHNOLOGY, INC. A person of ordinary skill in the art will appreciate that various other types of optical media changers and arrangements can be used and still be within the spirit of the invention.

Computer network 22 can be in the form of a Local Area Network (LAN), Municipal Area Network (MAN), Wide Area Network (WAN), such as the Internet, a combination of these, or such other network arrangement as would occur to those skilled in the art. The network can be wired, wireless, satellite, or by other arrangements as known in the art. The operating logic of system 20 can be embodied in signals transmitted over network 22, in programming instructions, dedicated hardware, or a combination of these. It should be understood that more or fewer computers 21 can be coupled together by computer network 22.

In one embodiment, system 20 operates as a CD/DVD conversion system at one or more physical locations with CD/DVD Processing Computer 24 being configured for transferring the data from the CD's/DVD's loaded into CD/DVD drive 42 from CD/DVD changer 28, Local CD/DVD Information Server 25 being configured as a local server for storing a CD/DVD Information Database 32, and External CD/DVD Information Server 26 being configured as an external server for storing a CD/DVD Information Database 34. It should be understood by one in the computer software art that various other computer arrangements are possible, such as one or more servers acting as both a Local CD/DVD Information Server and a CD/DVD Processing Computer, to name a non-limiting example. Applications of system 20 can include many more Computers 21 and many more CD/DVD Changers 28, at one or more physical locations, but only a few have been illustrated in FIG. 1 to preserve clarity.

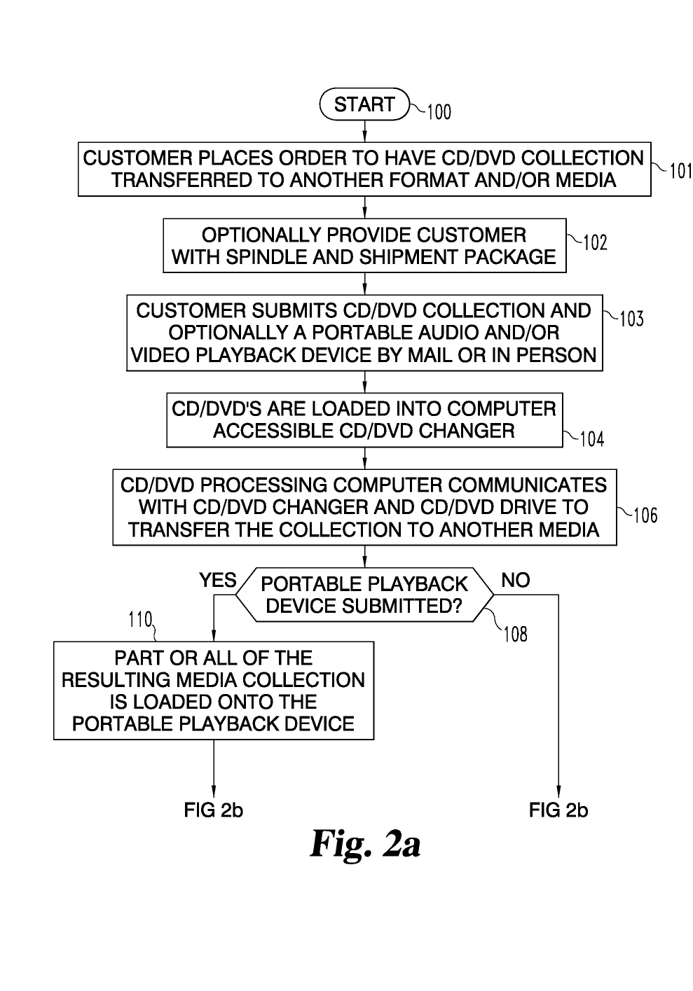

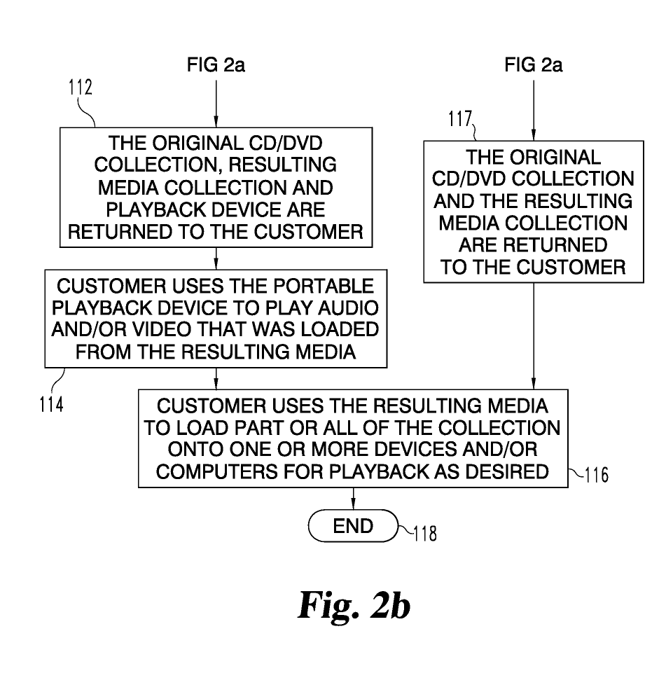

Referring to FIGS. 2A-2B with continued reference to FIG. 1, one embodiment for implementation with system 20 is illustrated in flow chart form as procedure 100, which demonstrates a high level process for transferring data from a collection of CD's into a collection of data on a different media or format. As one non-limiting example, the system and method of the present invention can be used to transfer a collection of CD's/DVD's containing audio and/or video into a compressed and encoded format, such as MP3 audio files. As another non-limiting example, the system and method can also be used to transfer a collection of audio and/or video CD's/DVD's into an uncompressed format, such as WAV files. As yet another non-limiting example, the system and method can be used to transfer a collection of data into an encrypted format. These are just a few non-limiting examples, and one in the art will appreciate that the process can be used for various purposes in addition to those specifically described herein.

In one form, procedure 100 is at least partially implemented in the operating logic of system 20. Procedure 100 begins on FIG. 2A with a customer placing an order to have a CD/DVD collection transferred to a different media and/or format (stage 101). The customer can optionally be provided with a CD/DVD spindle and a shipment package to assist in shipping the CD/DVD collection (stage 102). The customer then submits the collection of CD's/DVD's and optionally a portable digital audio and/or video playback device by mail or in person (stage 103). All or some of the CD's/DVD's are manually loaded into Multiple CD/DVD Holder 40 of Computer Accessible CD/DVD Changer 28 (stage 104). CD/DVD Processing Computer 24 communicates with CD/DVD Changer 28 and CD/DVD Drive 42 to load each CD/DVD and transfer the resulting media collection to one or more storage mediums, such as DVD's or CD's (stage 106).

If the customer submitted a portable digital audio and/or video playback device (decision point 108), then part or all of the collection is loaded onto the playback device (stage 110). Continuing with FIG. 2A, the original CD/DVD collection, newly created media collection, and playback device are returned to the customer (stage 112). The customer then uses the portable playback device to play audio and/or video that was loaded from the newly created resulting media collection(stage 114), and the customer can further use the resulting media collection to load all or part of the collection onto one or more devices and/or computers for playback as desired (stage 116).

If the customer did not submit a portable digital audio and/or video playback device (decision point 108), then the original CD/DVD collection and the newly created resulting media collection are returned to the customer (stage 107). The customer can then load part or all of the resulting collection onto a device such as a portable audio and/or video player, jukebox, or computer for playback as desired (stage 116).

Alternatively or additionally, the resulting media collection can be transferred to a web server for access by the customer and/or uploaded by FTP or other file transfer means to a server specified by the customer. The process then ends at stage 118.

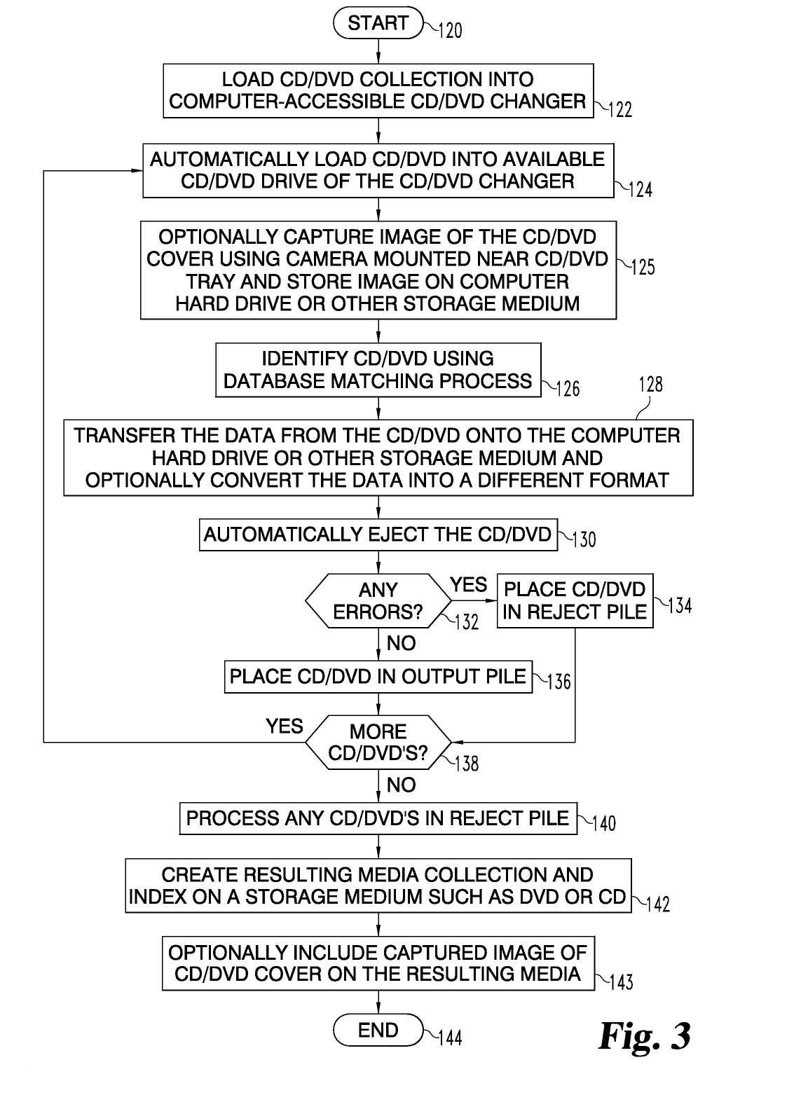

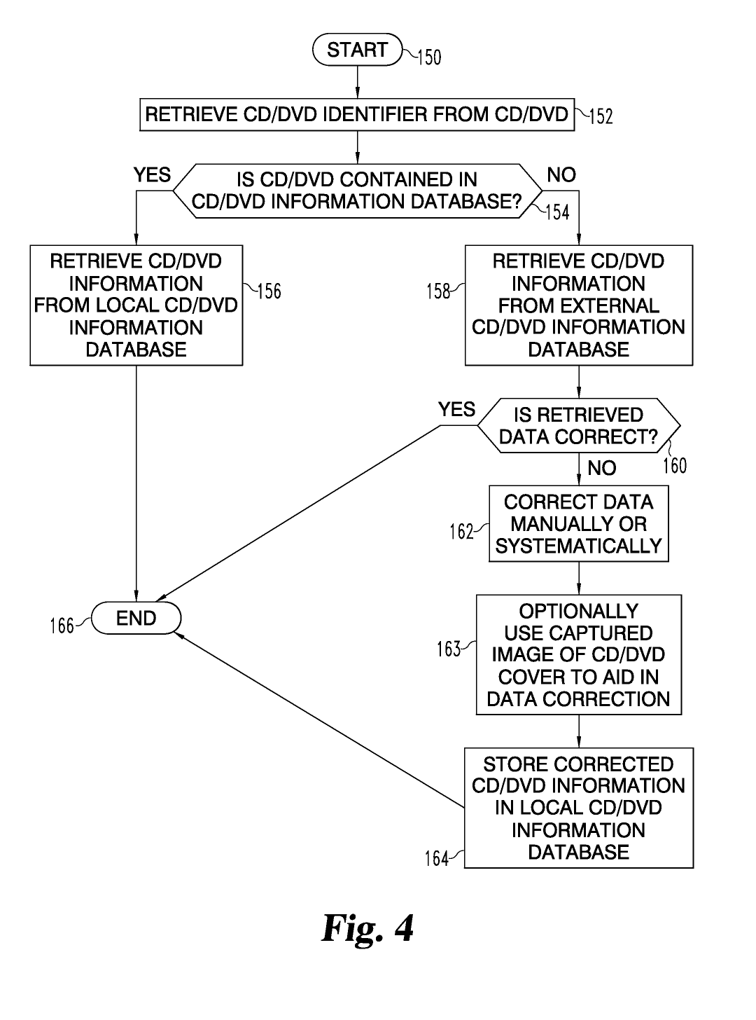

Referring to FIG. 3 with continued reference to FIG. 1, procedure 120 demonstrates in further detail a process for transferring data on a CD/DVD collection onto a different media or format. In one form, procedure 120 is at least partially implemented in the operating logic of system 20. Procedure 120 begins by loading all or some of the collection of CD's/DVD's into Multiple CD/DVD Holder 40 of Computer-Accessible CD/DVD Changer 28 (stage 122). A first CD/DVD is automatically loaded into CD/DVD Drive 42 (stage 124), such as upon communication from CD/DVD Processing Computer 24 or automatically upon inserting the group of CD's/DVD's into Multiple CD/DVD Holder 40. An image of the CD/DVD cover of the CD/DVD in CD/DVD Changer 28 is optionally captured using a camera mounted near the CD/DVD tray and an image is stored on a hard drive or other storage medium (stage 125). CD/DVD Processing Computer 24 communicates with CD/DVD Drive 42 of CD/DVD Changer 28 to read data from the currently loaded CD/DVD in CD/DVD Drive 42 and uses a database matching process to identify the CD/DVD (stage 126). The database matching process is described in further detail with reference to FIG. 4.

After the current CD/DVD has been identified, its contents are read from the CD/DVD in CD/DVD Drive 42 by CD/DVD Processing Computer 24 and transferred to a temporary storage medium, such as a hard drive present on CD/DVD Processing Computer 24 (stage 128). In one embodiment, the contents are transferred by ripping and encoding the data into a compressed format, either simultaneously or separately. Ripping is a term used to describe using a computer to copy uncompressed audio data from a CD/DVD to a storage device in a computer-recognizable format. Ripping does not require audio playback and thus can be performed at much greater speeds than 1×, which is the standard speed for audio playback. A variety of software products can be used to rip CD's/DVD's, as is known in the art. A variety of software products are available for encoding data into a desired format, as is known in the art. In another embodiment, the contents are not encoded in a compressed format, but are instead transferred and converted to an uncompressed format such as WAV. Such uncompressed files are larger in size than their compressed equivalent would be. In yet another embodiment, the contents are converted to an encrypted format. In another embodiment, the contents stored in the temporary storage medium are not converted to another format, but are preserved in their original format.

After the entire currently loaded CD/DVD has been transferred to the temporary storage medium, the currently loaded CD/DVD is ejected from CD/DVD Drive 42 of CD/DVD Changer 28 (stage 130). If any errors occurred during processing of the CD/DVD (decision point 132), the CD/DVD is placed in a reject pile (stage 134). If no errors occurred, the CD/DVD is placed into an output pile (stage 136). If more CD's/DVD's are present in Multiple CD/DVD Holder 40 (decision point 138), the next CD/DVD is loaded (stage 124). If any CDs are present in the reject pile, the errors are corrected. Errors that occurred during processing can be corrected in various ways, such as by manually cleaning the disk, trying to transfer the CD/DVD contents from using a different CD/DVD drive, and/or trying to transfer the CD/DVD contents again from the same drive, to name a few non-limiting examples. Once all of the CD's/DVD's have been processed correctly, CD/DVD Processing Computer 24 creates an Index file of the resulting media collection and loads the resulting collection and the Index file onto a storage media such as one or more DVD's or CD's (stage 142). In the case of audio files, each converted song track written to the portable storage media is tagged with an ID3 tag (an industry standard) or other similar type of tag. In other words, each song track file will have data appended that includes such details as album title, artist, track name, and/or cover art. In the case of video files, each converted video track written to the storage media can be tagged with data such as title, producer, cast, and production date, to name a few non-limiting examples. Some or all of this data can be used from the database matching process. The tags can be appended prior to writing the files to the media, simultaneously to writing the files to the media, or other variations as would occur to one in the art. Any captured images of the CD/DVD covers can be included on the compressed CD/DVD collection (stage 143). The process then ends at stage 144.

In one embodiment, multiple CD's/DVD's can be processed simultaneously. In such a scenario, CD/DVD Changer 28 has multiple CD/DVD drives 42. Also, Processing Computer 24 has CD/DVD processing software operable to call multiple instances of the conversion process that interact with the multiple CD/DVD drives 42 of CD/DVD Changer 28. After loading and beginning the transfer process of one CD/DVD, the next one is also loaded if a CD/DVD drive is available.

One of ordinary skill in the art will appreciate that in some cases the order of these steps described in FIG. 3 can be varied and still be within the spirit of the invention. As one non-limiting example, the data can be transferred to a storage device and then converted to a desired format afterwards, versus simultaneously. As another non-limiting example, all or part of the database matching process can be performed after transferring the data to a storage medium.

Referring to FIG. 4 with continued reference to FIGS. 1 and 3, procedure 150 demonstrates in further detail a process for identifying a CD/DVD using a database matching process (stage 126 of FIG. 3). In one form, procedure 150 is at least partially implemented in the operating logic of system 20. Procedure 150 begins by retrieving a CD/DVD identifier, such as the CDDB toc (an industry standard identifier), from the currently loaded CD/DVD in CD/DVD Drive 42 (stage 152). Alternatively or additionally, other identifiers or combinations thereof can be used to look up a CD and/or a DVD, such as by title and artist, to name one non-limiting example. CD/DVD Processing Computer 24 accesses CD/DVD Information Database 32 of Local CD/DVD Information Server 25 using the CD/DVD identifier to see if any information about that CD/DVD already exists locally (decision point 154). Internal CD/DVD Information Server 25 can include metadata about CD's, DVD's, both, or either. If information about the CD/DVD already exists in the local CD/DVD Information Database 32 (decision point 154), details about the CD/DVD are retrieved from that database without having to consult an external and possibly less accurate source (stage 156). In the case of audio files, details such as artist, album title, song title(s), publication date, and/or image of the cover can be retrieved. In the case of video files, details such as title, producer, cast, production date, and/or image cover can be retrieved.

If information about the CD/DVD does not already exist in the local CD/DVD Information Database 32 of Server 25 (decision point 154), CD/DVD details are retrieved from a CD/DVD Information Database 34 on External CD/DVD Information Server 26 (stage 158). External CD/DVD Information Server 26 can include metadata about CD's, DVD's, both, or either. Examples of external CD/DVD information databases include databases such as FreeDb. If the data about the CD/DVD retrieved from the external CD/DVD Information Database 34 is determined (manually or systematically) to be incorrect or missing (decision point 160), then the data is corrected (stage 162), such as from CD/DVD Processing Computer 24. The captured image of the CD/DVD cover can be used if applicable to aid in the data correction (stage 163). The corrected CD/DVD information is then stored in the local CD/DVD Information Database 32 of Server 25 so that it can be used in the future as the better and more reliable source (stage 164). Alternatively or additionally, the external CD/DVD Information Database 34 can be accessed first prior to checking the internal database. Alternatively or additionally, just a single database can be used. Alternatively or additionally, some information such as track information can be obtained from one database while other information such as cover art can be obtained from another database. Other variations for looking up CD/DVD information are also possible, as would occur to one in the art. The process then ends at stage 166.

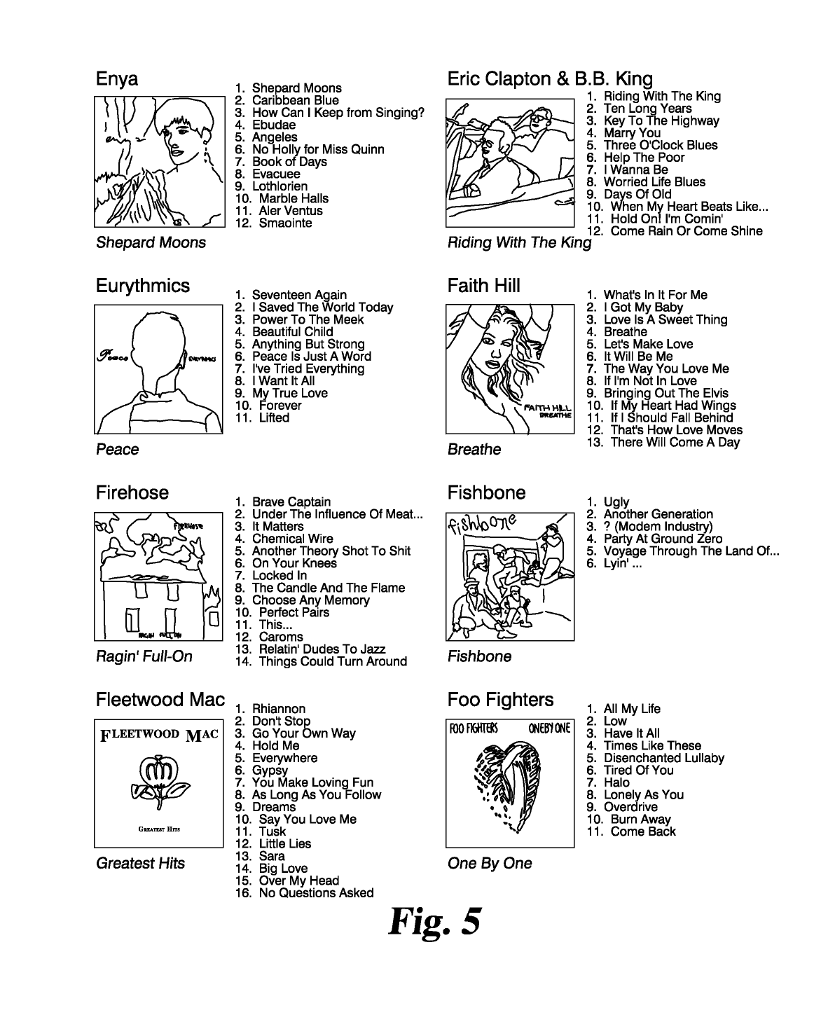

Referring to FIG. 5 with continued reference to FIG. 3, an example of what the contents of an Index file (stage 134 of FIG. 3) of a resulting media collection might look like is illustrated. The index file can be in a PDF, TIFF, or other format as would occur to one in the art. The Index contains an alphabetized list of the CD's/DVD's that were transferred along with a photo of the CD/DVD cover, and the individual song tracks on the CD. The CD's shown on the report in FIG. 5 are for illustration purposes only—the artists and songs on the report can alternatively be referred to generically as Artist 1, Artist 2, etc. and Song 1, Song 2, etc. Various other layouts, data details, sorting orders and formats can be used, as is known in the art. This Index file is loaded onto the resulting media collection, along with each of the transferred files themselves. The file structure of the one or more resulting media can be implemented in a variety of different ways. For the case of audio files, in one embodiment, the files are organized with a high level directory for each artist, a sub-directory for each artist album, and the individual song tracks listed in each respective artist album sub-directory. Various other variations are possible, as is known in the art.

Alternatively or additionally, the present invention can be used to provide a CD/DVD conversion station that a customer can personally visit. The customer loads multiple CD's/DVD's into a CD/DVD changer controlled by a computer, and follows one or more prompts on the computer to run an automated process for transferring the audio and/or video data on the CD's/DVD's to one or more storage mediums such as DVD's and/or a portable audio and/or video playback device, to name a few non-limiting examples.

In another embodiment, a method is disclosed that comprises: loading at least part of a plurality of optical media into an optical media changer; automatically loading a single optical media of the plurality of optical media from the optical media changer into an optical media reader; transferring data contained on the single optical media to a first storage medium; automatically ejecting the single optical media from the optical media reader; repeating said automatically loading, transferring, and automatically ejecting steps for each single optical media of the plurality of media loaded in the optical media changer; creating a collection of said data; and loading the collection of said data onto at least one second storage medium.

It yet another embodiment, a system is disclosed that comprises: an optical media reader; an optical media changer; and a computer, said computer being operable to: communicate with the optical media changer to automatically load a single optical media into the optical media reader from a plurality of optical media contained in the optical media changer; communicate with the optical media reader to transfer data contained on the single optical media to a first storage medium; communicate with the optical media reader to automatically eject the single optical media from the optical media reader; repeat said automatically loading, transferring, and automatically ejecting steps for each single optical media of the plurality of media loaded in the optical media changer; create a collection of said data; and load the collection of said data onto at least one second storage medium.

In yet a further embodiment, an apparatus is disclosed that comprises: a device encoded with logic executable by one or more processors to: communicate with an optical media changer to automatically load a single optical media into an optical media reader from a plurality of optical media contained in the optical media changer; communicate with the optical media reader to transfer data contained on the single optical media to a first storage medium; and communicate with the optical media reader to automatically eject the single optical media from the optical media reader; repeat said automatically loading, transferring, and automatically ejecting steps for each single optical media of the plurality of media loaded in the optical media changer; create a collection of said data; and load the collection of said data onto at least one second storage medium.

One of ordinary skill in the computer software art will appreciate that the functionality, components and/or devices described herein can be separated or combined on one or more computers or screens in various arrangements and still be within the spirit of the invention. While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

1. A method comprising:
loading at least part of a plurality of optical media into an optical media changer;
automatically loading a single optical media of the plurality of optical media from the optical media changer into an optical media reader;
transferring data contained on the single optical media to a first storage medium;
automatically ejecting the single optical media from the optical media reader;
repeating said automatically loading, transferring, and automatically ejecting steps for each single optical media of the plurality of media loaded in the optical media changer;
creating a collection of said data; and
loading the collection of said data onto at least one second storage medium.

2. The method of claim 1, wherein the first storage medium and the at least one second storage medium are the same.

3. The method of claim 1, wherein prior to said creating step, at least part of a remaining portion of the plurality of optical media are loaded into the optical media changer and wherein said automatically loading, transferring, automatically ejecting, and repeating steps are repeated for the at least part of the remaining portion of the optical media.

4. The method of claim 1, wherein the collection of said data is compressed.

5. The method of claim 1, wherein the collection of said data is encrypted.

6. The method of claim 1, wherein the optical media changer is a device that includes a stack and a robotic mechanism, said stack being operable to receive the at least part of the plurality of optical discs, and said robotic mechanism being operable to place a next optical disc from the stack and load said next optical disc into the optical media reader.

7. The method of claim 1, wherein the optical media are compact discs.

8. The method of claim 1, wherein the optical media are DVD discs.

9. The method of claim 1, wherein the plurality of optical media contain audio.

10. The method of claim 1, wherein the plurality of optical media contain video.

11. The method of claim 1, wherein the at least one second storage medium includes at least one DVD.

12. The method of claim 1, further comprising:
prior to said loading at least part of a plurality of optical media step, receiving the plurality of optical media from a customer; and
after said loading the collection step, returning the plurality of optical media and the at least one second storage medium to the customer.

13. The method of claim 12, wherein the receiving step further includes receiving a digital media playback device from the customer; wherein after said creating a collection step, at least a portion of the collection is loaded onto the playback device; and wherein said returning step further includes returning the playback device to the customer.

14. The method of claim 13, wherein the playback device is a portable digital audio player.

15. The method of claim 12, wherein the at least one second storage medium is provided by the customer.

16. The method of claim 12, wherein prior to said receiving step, an order is received from the customer and the customer is provided with a spindle and shipping materials to use in shipping the plurality of optical media.

17. The method of claim 1, wherein the optical media reader is coupled to the optical media changer.

18. The method of claim 1, wherein after ejecting the single optical media from the optical media reader, the single optical media is placed in a reject pile if errors were encountered while processing the single optical media.

19. The method of claim 18, wherein after said repeating step, each of the plurality of optical media located in the reject pile is processed for correction.

20. The method of claim 1, wherein after said automatically loading step, identifying the single optical media using a database matching process.

21. The method of claim 20, wherein said identifying step comprises:
retrieving an identifier from the single optical media; and
using the identifier to assist with retrieval of information associated with the single optical media from at least one information database.

22. The method of claim 21, wherein said using the identifier step includes retrieving information for the single optical media from a local information database if the single optical media is contained in the local information database; and if the single optical media is not contained in the local information database, retrieving information for the single optical media from an external information database.

23. A system comprising:
an optical media reader;
an optical media changer; and
a computer, said computer being operable to:
communicate with the optical media changer to automatically load a single optical media into the optical media reader from a plurality of optical media contained in the optical media changer;
communicate with the optical media reader to transfer data contained on the single optical media to a first storage medium;
communicate with the optical media reader to automatically eject the single optical media from the optical media reader;
repeat said automatically loading, transferring, and automatically ejecting steps for each single optical media of the plurality of media loaded in the optical media changer;
create a collection of said data; and
load the collection of said data onto at least one second storage medium.

24. The system of claim 23, further comprising:
at least one information server; and
wherein said computer is operable to communicate with said information server to retrieve information associated with the single optical media prior to communicating with the optical media reader to eject the single optical media.

25. The system of claim 23, wherein the optical media changer is a compact disc changer and the optical media reader is a compact disc reader.

26. The system of claim 23, wherein the optical media changer is a DVD disc changer and the optical media reader is a DVD disc reader.

27. The system of claim 23, wherein the optical media reader is coupled to the optical media changer.

28. The system of claim 23, wherein the optical media changer includes a robotic mechanism for loading and ejecting each of the plurality of optical media to and from the optical media reader.

29. An apparatus, comprising: a device encoded with logic executable by one or more processors to:
communicate with an optical media changer to automatically load a single optical media into an optical media reader from a plurality of optical media contained in the optical media changer;
communicate with the optical media reader to transfer data contained on the single optical media to a first storage medium;
communicate with the optical media reader to automatically eject the single optical media from the optical media reader;
repeat said automatically loading, transferring, and automatically ejecting steps for each single optical media of the plurality of media loaded in the optical media changer;
create a collection of said data; and
load the collection of said data onto at least one second storage medium.

30. The apparatus of claim 29, wherein the device includes a removable memory device carrying a number of processor executable instructions to define the logic.

31. The apparatus of claim 30, wherein the removable memory device includes a disk.
